(19) United States
(12) Patent Application Publication
(10) Pub. No.: US 2018/0119424 A1
(43) Pub. Date: May 3, 2018

(54) Building Multilayer Underlayments, Related Building Assemblies and Methods

(71) Applicant: Gardner-Gibson, Inc., Tampa, FL (US)

(72) Inventors: Amir G. Khan, Valrico, FL (US); Robert M. Hyer, Torrance, CA (US)

(73) Assignee: Gardner-Gibson, Inc.

(21) Appl. No.: 15/341,717

(22) Filed: Nov. 2, 2016

(51) Int. Cl. E04D 5/14; E04D 5/02; E04D 5/08; E04D 5/10; B32B 5/02; B32B 11/10

(52) U.S. Cl. CPC E04D 5/148; E04D 5/02; E04D 5/08; B32B 2419/00; B32B 5/022; B32B 11/10; E04D 5/10

(57) ABSTRACT

As described herein, the invention includes a building underlayment that has a first layer and a second layer each of a nonwoven fabric, and a reinforcing layer that is a support sheet saturated with an asphaltic material. The reinforcing layer is disposed between the first and the second layer. Also included are building assembles that are made up of a building surface, such as a roof surface, and the claimed building underlayment sheet. Methods encompassed in the invention include a method of waterproofing or imparting a water shedding properties to a roof of building surface by application of the underlayment sheet, methods of manufacture and methods of installation.

### BACKGROUND OF THE INVENTION

In the process of building construction, the building surfaces, including walls and roofs, are commonly covered in some type of membrane, barrier or building wrap before the final exterior surface, for example, shingles, siding or stucco, is applied. The building barrier or wrap serves to protect the structure of the house from the weather, especially moisture which may seep past the final exterior surface, e.g., the shingles or siding.

Conventionally, roofing barriers (“underlayments”, so called as they ‘underlay’ the final roof treatment of, e.g., shingle or tile) are applied to the surface of the roof (usually plywood) using a separately applied adhesive. However, in the construction process, the underlayment may be installed weeks or months before the final roof treatment. In this interim period the underlayment is exposed to the environment, including UV light, wind, and rain.

Conventional underlayment materials, such as for example, asphalt impregnated felts and other conventional synthetic products present various drawbacks including a lack of durability both during the interim construction period and post-application of the final roof treatment.

There remains a need in the art for an underlayment, that is easy to install, durable, even, at extreme temperature, is nail sealable, and provides water shedding and/or water proofing properties to the surface to which it is applied.

### BRIEF SUMMARY OF THE INVENTION

The invention encompasses a building underlayment that has a first layer and a second layer each of a nonwoven fabric, and a reinforcing layer that is a support sheet saturated with an asphaltic material. The reinforcing layer is disposed between the first and the second layer.

Also contemplated within the scope of the invention are building assembles that are made up of a building surface, such as a roof surface, and the building underlayment sheet of the invention.

Also included are methods of waterproofing a surface exposed to an outdoor environment and of imparting a water shedding property to a surface by applying a bottom surface of the second layer of the building underlayment to a building surface and a affixing the underlayment to the building surface.

The invention further includes a method of manufacture of an underlayment sheet for a roof surface comprising applying a liquid asphaltic material to a support sheet until the support sheet is substantially saturated and laminating the asphaltic material-impregnated reinforcing layer between a first non woven fabric sheet and a second non woven fabric sheet to form a multilayered underlayment sheet.

### BRIEF DESCRIPTION OF THE SEVERAL VIEWS OF THE DRAWINGS

The foregoing summary, as well as the following detailed description of various embodiments of the invention, may be better understood when read in conjunction with the appended drawings. For the purpose of illustrating the invention, there is shown in the drawings embodiments which may be presently preferred. It should be understood, however, that the invention is not limited to the precise arrangements and instrumentalities shown.

In the drawings:

FIG. 1 is a schematic of the underlayment of the invention, shown in exploded cross section; and

FIG. 2 is a schematic process chart showing the process of manufacture of the underlayment of the invention.

### DETAILED DESCRIPTION OF THE INVENTION

The invention described herein encompasses: a underlayment that can be used to waterproof or to impart a water shedding property to a surface, such as a roof surface of a home or other building; a building assembly that includes the underlayment, methods of waterproofing and imparting water shedding properties to a building surface, method of installation of the underlayment and methods of manufacture.

The underlayment of the invention provides the advantages of conventional asphalt impregnated felts and other conventional synthetic products without their drawbacks, i.e., the underlayment of the invention provides high performance and durability, with easy and quick installation. The underlayment of the invention is tear resistant, even when wet, durable, even under conditions of extreme heat or cold, remains secure in high winds.

The invention in some embodiments will be described using lexicon of relative spatial import, “top”, “bottom”, “inner” and “outer,” “upper” and “lower,”, “inwardly” and “outwardly,” etc. Such words are used for assisting in the understanding of the invention and absent a specific definition or meaning otherwise given by the specification for such terms, should not be considered limiting to the scope of the invention.

The underlayment includes a first layer and a second layer, each of which are made of a nonwoven fabric. Both layers may, but need not be, made of the same type of fabric and/or fabric material. The nonwoven fabric chosen may be any known or to be developed in the art. Suitable fabrics may be staple nonwoven fabrics or may be prepared by any other “no weave” procedure, e.g., mechanically, thermally, or chemically, for example, they may be melt blown, spun bond, stitch bonded, or similar.

The nonwoven fabric(s) selected may be made of any material having durability and waterproof or water resistant capacity. Examples of suitable materials may include polypropylene, polyester, viscose, cellulose, rayon, polyethylene terephthalate, fiberglass, and/or combinations thereof. In some embodiments, one may prefer that one or both of the layers is of a non woven polypropylene fabric of about 20 to about 45 gsm, or of about 10 to about 55 gsm.

In the underlayment of the invention, a reinforcing layer is disposed between the first and second layers of nonwoven fabric. The reinforcing layer is made up of a support sheet that is impregnated with an asphaltic material. It is preferred that the support sheet is made of a durable but flexible material. Example of such material may include various elastomers or fluoroelastomers, polypropylenes, polyesters, and copolymers and blends of the same. In an embodiment, continuous polyester sheet of about 80 to about 130 gsm may be preferred.

In the manufacture of the underlayment reinforcing layer, an asphaltic material is applied to the support sheet in a liquid or semi-liquid form. The asphaltic material may be a neat asphalt, a polymer-modified asphalt (PMA), or either of these with one or more additives included to alter its properties.

Other additives may include, for example, tackifing oils, fillers, chemical modifiers, extenders, oxidants and antioxidants, hydrocarbons and anti-stripping additives.

Any tackifiers known or to be developed in the art my be used, including, for example, rosins and their derivatives, terpenes and modified terpenes, aliphatic, cycloaliphaitic, and aromatic resins, hydrogenated hydrocarbon resins, and their mixtures, terpene-phenol resins. In an embodiment, the tackifier may include rubbers (natural or synthetic) and a tackifying resin, as well as, for example, low molecular weight hydrocarbon resins, e.g., without limitation, C₅ to C₂₀ hydrocarbons. An example may be NP25 (from Neville Chemical Company, Pittsburgh, Pa.) or Piccotac™ (from Eastman Chemical Company, Kingsport, Tenn.). Tackifing oils, may include, without limitation, paraffinic based oils (Kendex 150 m), used process oils such as Safety Kleen and/or used motor oils.

If used, the filler or fillers may be any known or to be developed in the art. Examples of suitable fillers include, without limitation, limestone, chalk, talc, carbon fibers, carbon black, ground tire rubber, carbon nanotubes, laponite, silica, ash, china clay, calcium carbonate, smectite and mixtures thereof.

If a polymer modified asphalt is used, the modifying polymer may be, for example, an elastomer, a plastic, styrene-butadiene rubber (SBR), styrene-isoprene-styrene, styrene-butadiene-styrene (SBS), low density polyethylene (LDPE), ethylene vinyl acetate (EVA) and blends, copolymers and combinations thereof.

In some embodiments, the asphaltic material it may be preferred that the penetration value of the material is about 100 to about 200 dmm @60° C. and its softening point of about 100 to about 150° C.

For certain end use applications, it may be preferred that the asphaltic material is a polymer modified asphalt, containing tackifier and fillers. In such embodiment: (i) asphalt may be present in an amount of about 30% to about 75% or 40% to about 65%; (ii) polymer(s) may be present in an amount of about 1% to about 15% or about 5% to about 9% by weight; (iii) tackifier(s) may be present in an amount of about 0 to about 20% or about 5% to about 15%; and (iv) filler(s) may be present in an amount of about 5% to about 40% or about 10% to about 30%; all by total weight of the composition.

In the fabrication of the reinforcing layer the liquid asphaltic material is applied to the support sheet until the support sheet is substantially saturated. By “substantially saturated” it is meant that the entire surface of each side of the support, sheet is coated with asphaltic material at a reasonably uniform thickness. Such state can be achieved, for example, by dipping the support sheet in the asphaltic material and running the dipped sheet through calendar rolls. In an embodiment, one may wish to dip a continuous polyester sheet of about 95 gsm in a PMA of 235 gsm, and subsequently squeezing the dipped sheet through calendar rolls to arrive at desired overall weight for the reinforcement sheet and to ensure the PMA is applied uniformly.

The overall weight if the reinforcing sheet can vary. In some embodiments, it may be about 100 gsm to 500 gsm, or about 200 gsm to about 400 gsm.

The underlayment of the invention has been described thus in terms of a 3-part laminate. However, it should be appreciated that additional coating or layers can be disposed on either side of the first and second layers, within or outside of the 3-part laminate. For example, the top surface of the first layer, which is exposed to the environment when the underlayment is installed may include an additional coating layer or layers. Such additional layer(s) may be applied in a pre-formed sheet format, at the installation site or at the factory. Alternatively, such additional layer may be applied in liquid or semi liquid form, once the underlayment is in situ.

The additional layer(s) may serve to provide texture, color, or another desirable property to the underlayment. For example, such coating layer(s) could include, without limitation, a modified bitumen or asphalt-based composition, a UV reflecting material, a UV absorbing material, a fire retardant, such as, for example, compositions containing calcium borate, magnesium borate, antimony tri-oxide, and/or decabromo diphenyl oxide, a texturizing material, etc.

In an embodiment, the additional layer of the top surface is designed to provide traction and/or slip resistance to the installer, who may walk on the top surface as he or she is installing the underlayment. The traction or slip resistance can be achieved by applying a material to the top surface (such as a curable suspension of grit or other particles) and/or may be in the form of a texturized surface molded onto or into the coating layer.

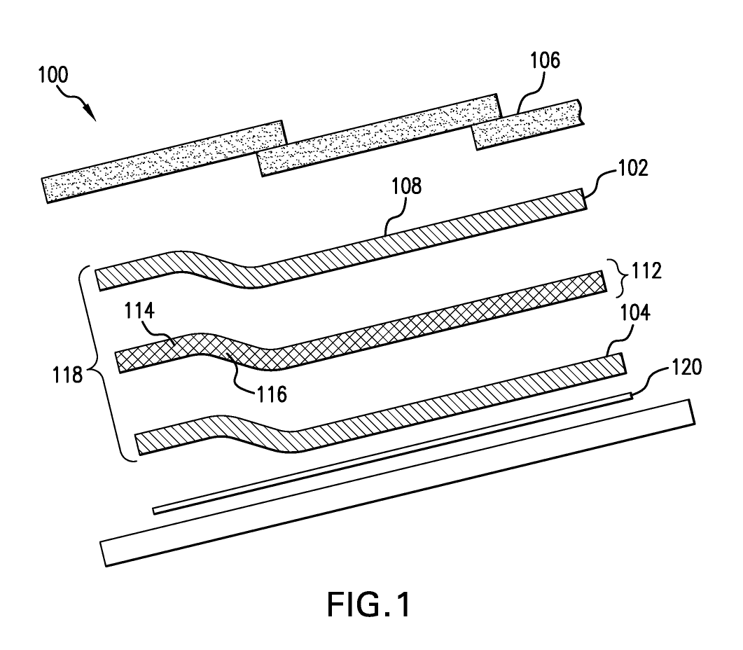

With reference to FIG. 1, a basic embodiment of a building assembly 100 including an underlayment 118 of the invention in situ on a roof surface 110 is illustrated in exploded cross section. As can be seen, the underlayment 100 includes a first layer 102 and a second layer 104. The first layer 102 includes a top surface 108 that, upon installation, is exposed to the outside environment, either directly (not shown) or indirectly, i.e., when covered by a final roof treatment of shingles 106. In between the first layer 102 and the second layer 104 is a reinforcing layer 112. The reinforcing layer 112 is made of a support sheet 114, which, in the finished underlayment, is interlined with a cured/dried asphaltic material 116. The underlayment 118 is affixed to the roof 110 by a pressure sensitive adhesive layer 120.

The underlayment is manufactured as is known in the art. For example, a PMA is prepared by heating the asphalt to about 185° C. and the polymer(s) added. Once the polymer is fully digested into the asphalt blend, the tackifier and the fillers are added. The asphaltic material, now in a viscous liquid form, is applied to the support sheet until the support sheet is substantially saturated with it. The asphaltic material-bearing support sheet (i.e., the reinforcing layer) is limited between the first and the second nonwoven fabrics.

The lamination step may occur under heat or under pressure, or both. For example, the underlayment could be passed through a set of heated calendaring rollers to apply both heat and pressure.

For roofing applications, it may be preferred that, the underlayment has an aspect ratio where the width is significantly less than the length, so the finished underlayment can be configured into rolls for storage, delivery and easy installation. For example, the preferred aspect ratio may be about 1:20 to 1:50.

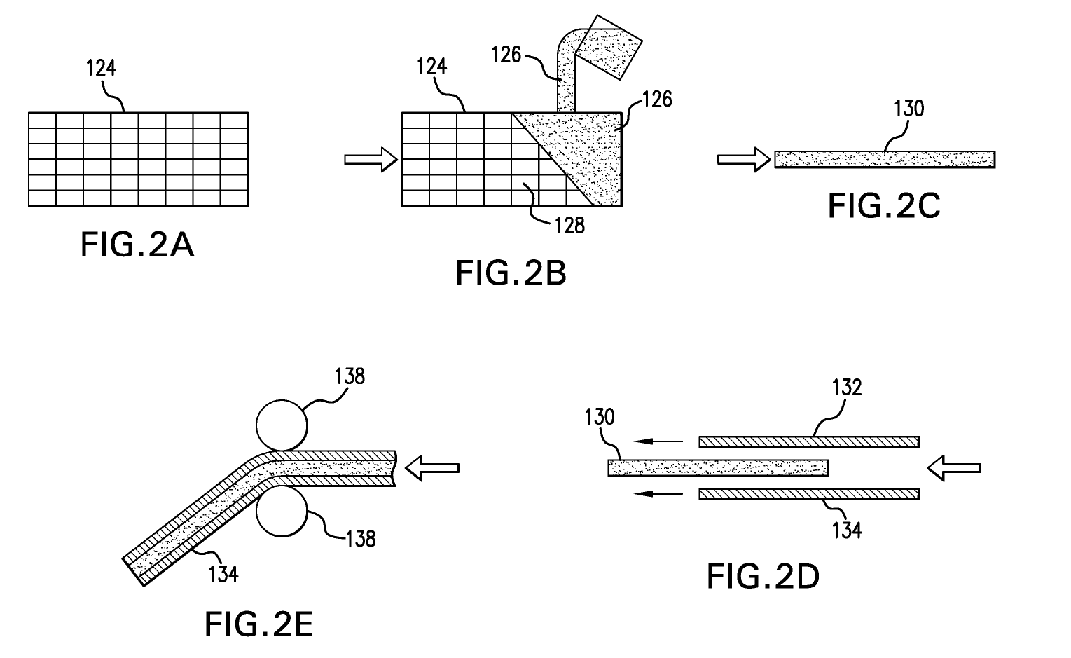

Referring to FIG. 2, a support sheet 124 of desired dimensions (shown in plan view) is saturated with an asphaltic material 126 when the asphaltic material is in liquid or semi liquid form (Steps A and B). This can be accomplished via any means, including, for example, dipping the support sheet in the asphaltic material, brush, scooping or pouring asphaltic material on to the support sheet and/or spraying it on to the support sheet. The asphaltic material 126 impregnates the sheet 128 of the support sheet 124 to form a reinforcing layer, shown in cross section at step C. Prior to the completion of drying of the asphaltic material 126, the reinforcing sheet 130 placed between a first nonwoven layer 132 and a second nonwoven layer 134, and laminated together, form example, by passing it though high pressure rollers 138, 138′, to form an underlayment 136 (shown in cross section). (Shown in steps D and E).

The underlayment of the invention is applied to a building surface, such as a roof surface. Any means known in the art can be utilized. In general terms, the underlayment sheet is affixed on a building surface. Since the nail sealability of the underlayment sheet may meets or may be better than the ASTM standard (ASTM D1970), such affixation may be carried out using mechanical fasteners, such as nails or pins, adhesive, heat, pressure or any combinations of these, or by use of an adhesive, such a pressure sensitive adhesive or a heat sensitive adhesive.

When applied to the building, the underlayment provides waterproofing to the surface, and/or imparts a water shedding property to the surface.

In an embodiment, the underlayment is self-adhesive—that is, an adhesive layer is applied to the bottom of the second layer during manufacture. In such instance, an installer need only contact the underlayment with the building surface and activate the adhesive if necessary, by application of, for example, heat or pressure.

The underlayment may be overlaid with a final roofing treatment. Any known or developed in acceptable. Exemplary treatments may include thatch, metal or wood, and one or an array of tiles, shingles or plates, such as wood shake, wood shingles, asphalt shingles, metal tiles, metal plates, metal sheets, ceramic tiles, clay tiles, terra cotta tiles, solar panels, thermoplastic tiles or plates and the like.

The desired technical and physical properties of the final underlayment will vary, depending on the specifics of the end use application. However, in many embodiments, it may be preferred that the physical specifications of the underlayment are at or near those set our in Table I.

TABLE I
Technical Physical and Performance Characteristics

| Permeability, ASTM E96 | 0.05 | Perms |
|---|---|---|
| Water Transmission ASTM D4869 | Pass | |
| Tear ASTM D192 | >5 | lbf |
| Tensile ASTM D146 | >110 | lbf |

| | |
|---|---|
| Thickness (mil) ASTM D1777 | 20 |
| Net Mass (g/m2) ASTM D5261 | 420 |
| Temperature Range | −40° F. to 240° F. |
| Dimensional Stability, ASTM F1087 | Pass |
| Pliability, ASTM D146 | Pass |

Each ASTM cited above is incorporated herein by reference in its entirety.

### Example 1

A multi-layered underlayment in accordance with the invention is prepared. An asphaltic material is prepared by heating asphalt to 185° C. and mixing in polymer in the amounts shown in Table II, below. Once fully digested, the tackifier and the talc filler are and (in the amounts shown in Table II). The heated and completed mix is sent to the process coater,

TABLE II

| | Amount |
|---|---|
| | (wt % by weight of |
| Ingredient | total composition) |
| Asphalt | 60 |
| Styrene-Butadiene-Styrene Polymer | 5 |
| Tackifier (PICCOTAC and NP 25) | 5 |
| Talc filler | 30 |
| Total | 100 |

A polyester support sheet of 95 gsm, and having a dimension of 100 feet×30 feet is obtained. Using the process coater, the support sheet is saturated asphaltic material to form a reinforcing sheet having a total gsm of 330.

Two sheets of nonwoven polypropylene fabric of gsm 45 and of the same dimensions as the support sheet are obtained. The reinforcing sheet is heat laminated between the polypropylene fabric sheets. The resultant underlayment is allowed to cool and cure.

Subsequently, a coating of a UV absorbing material borne in an acrylic carrier is applied to one surface of the underlayment by spray coating. Once the coating has dried, the underlayment is rolled up with the UV absorbing layer facing inwardly to form a roll. The roll is packaged and labeled.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A building underlayment comprising a first layer and a second layer each comprising a nonwoven fabric, and a reinforcing layer comprising a support sheet saturated with an asphaltic material, wherein the reinforcing layer is disposed between the first and the second layer.

2. The building underlayment of claim 1, wherein the first layer and a second layer each comprise a nonwoven fabric including a material independently selected from polypropylene, polyester, viscose, cellulose, rayon, polyethylene terephthalate, fiberglass, and/or combinations thereof.

3. The building underlayment of claim 1, wherein the first layer and a second layer each comprise a nonwoven fabric including polypropylene.

4. The building underlayment of claim 1, wherein the first layer and the second layer each independently comprise a different nonwoven fabric.

5. The building underlayment of claim 1, wherein the support sheet is made of material selected from polyester.

6. The building underlayment of claim 1, wherein the asphaltic material is selected from material comprising asphalt and a polymer modified asphalt (PMA).

7. The building underlayment of claim 4, wherein the polymer of the PMA is selected from an elastomer, a plastic, styrene-butadiene rubber (SBR), styrene-isoprene-styrene, styrene-butadiene-styrene (SBS), low density polyethylene (LDPE), ethylene vinyl acetate (EVA) and blends, copolymers and combinations thereof.

8. The building underlayment of claim 1, wherein the asphaltic material further comprises a material selected from a filler, a tackifier, a chemical modifier, as asphalt binder extender, a softening agent, a rejuvenators, a colorant, and mixtures thereof.

9. The building underlayment of claim 1, wherein the filler is selected from ground rubber tires (GTR), limestone, chalk, talc, carbon fibers, carbon black, carbon nanotubes, laponite, silica, ash, china clay, calcium carbonate, smectite and mixtures thereof.

10. The building underlayment of claim 1, wherein the first layer has a top surface that is exposed to the environment when the building underlayment is installed, and the top surface bears an additional coating layer.

11. The building underlayment of claim 8, wherein the coating layer comprises a bitumen-based composition, a UV reflecting materials, a UV absorbing material, a fire retardant, a texturizing material, and combinations thereof.

12. A building assembly comprising: a building surface; and the building underlayment sheet of claim 1, wherein the underlayment sheet is adhered to the building surface.

13. The assembly of claim 10, wherein the surface is a roof surface

14. A building assembly comprising: a building surface; and the building underlayment sheet of claim 1, wherein the underlayment sheet is adhered to the building surface.

15. A method of waterproofing a surface exposed to an outdoor environment comprising applying a bottom surface of the second layer of the building underlayment of claim 1 to a building surface and a affixing the underlayment to the building surface.

16. The method of claim 13, wherein affixation is accomplished by application of heat and/or pressure to the underlayment sheet as it contacts the building surface.

17. The method of claim 13, wherein the building surface is a roof surface.

18. The method of claim 13 further comprising placing a secondary surface over the underlayment, wherein the secondary surface is selected from a metal sheet, a thatch, and an array of ceramic tiles, of clay tiles, of asphalt shingles, of slate shingles, of metal plates, of wood shake shingles, and combinations thereof.

19. A method of imparting a watershedding property to a surface comprising applying a bottom surface of the second layer of the building underlayment of claim 1 to a building surface and a affixing the underlayment to the building surface.

20. The method of claim 17, wherein affixation is accomplished by application of heat and/or pressure to the underlayment sheet as it contacts the building surface.

21. The method of any of claim 17, wherein the building surface is a roof surface.

22. The method of any of claim 17, further comprising placing a secondary surface over the underlayment, wherein the secondary surface is selected from a metal sheet, a thatch, and an array of ceramic tiles, of clay tiles, of asphalt shingles, of slate shingles, of metals plates, of wood shake shingles, and combinations thereof.

23. A method of manufacturing an underlayment sheet for a roof surface comprising applying a liquid asphaltic material to a support sheet until the support sheet is substantially saturated and laminating the asphaltic material-impregnated support sheet between a first non woven fabric sheet and a second non woven fabric sheet to form a multilayered underlayment sheet.

24. The method of claim 21 wherein lamination is accomplished by an application of heat, of pressure and a combination thereof.
